(19) United States
(12) Patent Application Publication
(10) Pub. No.: US 2017/0103672 A1
(43) Pub. Date: Apr. 13, 2017

(54) SYSTEM AND METHOD FOR GESTURE CAPTURE AND REAL-TIME CLOUD BASED AVATAR TRAINING

(71) Applicant: The Regents of the University of California, Oakland, CA (US)

(72) Inventors: Sujit Dey, San Diego, CA (US); Wenchuan Wei, La Jolla, CA (US); Yao Lu, La Jolla, CA (US)

(21) Appl. No.: 15/290,733

(22) Filed: Oct. 11, 2016

Related U.S. Application Data
(60) Provisional application No. 62/239,481, filed on Oct. 9, 2015.

(51) Int. Cl. G09B 19/00; G06F 3/01; G06T 7/00; G06K 9/00

(52) U.S. Cl. CPC G09B 19/0038; G06K 9/00342; G06F 3/017; G06F 3/011; G06T 7/003; G06T 2207/30196; G06T 2207/10016

(57) ABSTRACT

Systems and methods for virtual training are provided. The systems and methods resolves user gestures in view of network and user latencies. Subsequences in the user responsive gesture data are aligned with subsequences in the avatar video data. Correction data can be generated in real time to send through the network for use by the display device.

### PRIORITY CLAIM AND REFERENCE TO RELATED APPLICATION

The application claims priority under 35 U.S.C. §119 from prior provisional application Ser. No. 62/239,481, which was filed Oct. 9, 2015.

### STATEMENT OF GOVERNMENT INTEREST

This invention was made with government support under grant number IIS-1522125 awarded by National Science Foundation. The government has certain rights in the invention.

### FIELD

A field of the invention concerns interactive gesture acquisition systems. Example applications of the invention include cloud based training systems that compare user gestures at a user device, such as a mobile handset, to training representations, e.g. training avatars. Such systems can be useful for training users to conduct sports related or artistic movement related activities, or can be used to guide users in physical therapy related movements.

### BACKGROUND

Physical therapy is a widely used type of rehabilitation in the treatment of many diseases. Normally, patients are instructed by specialists in physical therapy sessions and then expected to perform the activities at home, in most cases following paper instructions and figures they are given in the sessions. Useful feedback about at-home performance is unavailable and patients therefore have no idea how to improve their training without the supervision of professional physical therapists. To address this problem, some automatic training systems have been created to evaluate people's performance against standard or expected performance.

Some training systems provide virtual instructors generated by computing resources that are presented to a user via a user device, such as a computer, handset, game system or the like. User gestures are acquired by the end device and data about gestures is provided to the computing system. Systems can evaluate user performance based upon comparing sensed gestures to idealized movements. Various difficulties are encountered in attempting to match acquired gesture data to virtual or ideal models, and many fail to address mismatch error.

One approach for addressing such mismatch is provided by D. S. Alexiadis, et al., “Evaluating a dancer's performance using kinect-based skeleton tracking,” in Proc. of the 19th ACM international conference on Multimedia (MM'11), Scottsdale, November, 2011. This approach uses a Maximum Cross Correlation (MCC) algorithm, which assumes a constant shift between the standard/expected motion sequence and the user's motion sequence.

Another approach is provided by A. Yurtman, and B. Barshan, “Detection and evaluation of physical therapy exercises by dynamic time warping using wearable motion sensor units,” Information Sciences and Systems (SIU'14), Trabzon, April, 2014. This approach pre-defines a number of correct and incorrect templates and judges user performance by finding the best match of the user's execution among these templates.

One group proposed using the marker-based optical motion capture system Vicon and proved its effectiveness in gait analysis on subjects with hemiparesis caused by stroke. A. Mirelman, B. L. Patritti, P. Bonato, and J. E. Deutsch, “Effects of virtual reality training on gait biomechanics of individuals post-stroke,” Gait & posture, 31.4 433-437; (2010). Others demonstrated that the Microsoft Kinect sensor can provide high accuracy and convenient detection of the human skeleton compared with wearable devices. C. Y. Chang, et al., “Towards pervasive physical rehabilitation using Microsoft Kinect,” Pervasive Computing Technologies for Healthcare (PervasiveHealth'12), San Diego (May, 2012). Others developed a game-based rehabilitation system using Kinect for balance training. B. Lange, et al., “Development and evaluation of low cost game-based balance rehabilitation tool using the Microsoft Kinect sensor,” Engineering in Medicine and Biology Society (EMBC'11), Boston, (September, 2011).

The Maximum Cross Correlation (MCC) computes the time shift between the standard/expected motion sequence and the user's motion sequence. D. S. Alexiadis, et al., “Evaluating a dancer's performance using kinect-based skeleton tracking,” in Proc. of the 19th ACM international conference on Multimedia (MM'11), Scottsdale, (November, 2011). In this MCC technique, the user's motion sequence is shifted by the estimated time shift, the two sequences are aligned and their similarity is then calculated. For two discrete-time signals f and g, their cross correlation R_{f,g}(n) is given by:

$${R}_{f , g} ( n ) = {\sum }_{m = - ∞}^{∞} {f}^{*} ( m ) g ( m + n ) \qquad ( 1 )$$

and the time shift τ of the two sequences is estimated as the position of maximum cross correlation:

$$τ = {argmax}_{n} \{ {R}_{f , g} ( n ) \} \qquad ( 2 )$$

In the MCC process, when the lengths of the two sequences are very close, shifting one sequence by the estimated delay τ can align them and their similarity can be calculated. The present inventors have determined, however, that this MCC method merely calculates the overall delay for the entire sequence once it is complete (and off-line) and cannot address the problem of variant human reaction delay and network delay.

An application of dynamic time warping (DTW), normally applied to speech recognition, was proposed to align movement data where the movement data was acquired with discrete wearable sensors. See, A. Yurtman, and B. Barshan, “Detection and evaluation of physical therapy exercises by dynamic time warping using wearable motion sensor units,” Information Sciences and Systems (SIU'14), Trabzon, April, 2014. This approach involved finding the best match of the user's execution among some correct and incorrect templates to judge the user's performance and provide an indication of the type of errors committed. The need for templates and the need to work off-line after receiving a complete set of data, as in the other approaches above, limits the usefulness of this approach.

More recently, cloud based training systems have been proposed. One cloud based system is proposed by Dennis Shen, Yao Lu and Sujit Dey “Motion Data Alignment and Real-Time Guidance in Avatar Based Physical Therapy Training System.” In Proceedings of IEEE International Conference on E-health Networking, Application & Services (Healthcom), October 2015, Boston. This system enables a user to be trained by following a pre-recorded avatar instructor and getting real-time guidance using mobile device through wireless network. While matching is addressed, there is no attempt to address network latency and mismatches caused by network delays. This limits the accuracy of the technique.

The present inventors have identified the failure to address network delays in attempting matching as s a problem and also human induced delay as an issue to address. Difficulties in these types of systems include latencies. One type of latency is human reaction to a virtual instructor. Another type of latency includes data acquisition and transmission decays, which can be referred to as network delays. Inconsistency in the amount of the two types of delays causes difficulties in evaluating user performance because it is difficult to align the performance of the user's acquired gesture motion data and the virtual instructor motion data.

### SUMMARY OF THE INVENTION

An embodiment of the invention is a server for virtual training that transmits avatar video data through a network for use by a display device for displaying a virtual trainer and receives user data generated by a gesture acquisition device for obtaining user responsive gesture data. The server includes a processor running code that resolves user gestures in view of network and user latencies. The code aligns subsequences in the user responsive gesture data with subsequences in the avatar video data and generates correction data to send through the network for use by the display device. The correction data can be generated and sent through the network in real time for display by the display device. The correction data can be avatar video data and/or text. The code preferably aligns subsequences via modified dynamic time warping. The modified dynamic time warping comprises pre-processing to first align two starting points by shifting a subsequence in the user responsive gesture data by a constant to align with a first point in a subsequence of the avatar video data and produce pre-processed data. The subsequences in the user responsive gesture data and the subsequences in the avatar video data can correspond to individual physical gestures in a sequence of physical gestures or can correspond to a predetermined number of frames.

The code preferably determines an optimal warping path to the preprocessed data and then applies the optimal path to subsequences in the user responsive gesture data and the avatar video data. The code preferably determines an optimal endpoint of user responsive gesture data as a frame of the data the leads to the best match between subsequences in the user responsive gesture data and the avatar video data and provides the minimum dynamic time warping distance. The code preferably estimates a global minimum point by detecting a movement transition data, determining a local minimum point for a subsequence of data between movement transition data, and then testing for a global minimum for a number of following frames via calculation of warping distances. The code further preferably estimates dynamic time warping distances for subsequent frames and calculates an error vector between this estimated warping distances and the true warping distances for the subsequent frames. The code can the code determine a global minimum when the error vector is less than a predetermined threshold.

In preferred embodiments, the code calculates two dynamic time warp vectors to test each local minimum point in subsequences. The two vectors include a true dynamic time warp distance vector and an estimated dynamic time warp distance vector and the code assigns a global minimum point when the true dynamic time warp distance vector and an estimated dynamic time warp distance vector are within a predetermined error range.

A preferred system of the invention includes a server and a client device, The client device includes a video encoder for encoding the avatar video data, the display device for displaying the virtual trainer, a gesture acquisition device for sensing user movements, and a network interface for receiving the avatar video data and transmitting the user responsive gesture data to the server.

A preferred method for aligning avatar video data with user responsive gesture data includes dividing the user responsive gesture data into subsequences by testing for local minimums in a subsequence of frames and calculating warping distances, and then testing subsequent frames to find an estimated global minimum that meets a predetermined error threshold range. Dynamic time warping is performed on subsequences in the user responsive data with subsequences in the avatar video data. Correction data is generated from the warping. Preferably, preprocessing is conducted on the user responsive gesture data by aligning the starting points of subsequences in the user responsive gesture data and the avatar video data.

### BRIEF DESCRIPTION OF THE DRAWINGS

FIG. 1 is a schematic diagram of a preferred embodiment system for virtual training in accordance with the invention;

FIGS. 2A and 2B respectively illustrate a user movement of an arm and motion data (i.e., left shoulder angle) of the avatar instructor and the user in an exercise of three gestures to illustrate human reaction or each gesture as τ₁, τ₂, τ₃;

FIG. 3 includes the motion data of FIG. 2B with both human reaction delay and network delay, where the user performs the third gesture longer than the avatar instructor (L₃′>L₃) due to network delay;

FIGS. 4A and 4B respectively illustrate a warping path of a dynamic time warp of two sequences and the alignment result of the sequences;

FIG. 5 illustrates computational complexity of a gesture segmented dynamic time warp of user movements in accordance with a preferred embodiment method of the invention;

FIG. 6 defines for types of user movements defined in a gesture segmented dynamic time warp in accordance with a preferred embodiment method of the invention;

FIG. 7 is a sequence of visual and textual guidance provided to the user through the display of the system of FIG. 1;

FIG. 8 illustrates an experimental testbed that was used to model the system of FIG. 1; and

FIG. 9 illustrates an avatar instructor motion data for four gestures and a network bandwidth profile to simulate network delays.

### DETAILED DESCRIPTION OF THE PREFERRED EMBODIMENTS

An embodiment of the invention is a system for virtual training that includes a display device for displaying a virtual trainer, a gesture acquisition device for obtaining user responsive gestures, communications for communicating with a network and a processor that resolves user gestures in view of network and user latencies. Code run by the processor addresses reaction time and network delays by assessing each user gesture independently and correcting gestures individually for comparison against the training program. Errors detected in the user's performance can be corrected with feedback generated automatically by the system.

Preferred embodiment systems overcome at least two limitations in current remote training and physical therapy technologies. Presently, there exist systems which enable a remote user to follow along with a virtual therapist, repeating movements that are designed to improve strength and/or mobility. The challenge, however, is in assessing the quality and accuracy of the user's movements. Incorporating motion capture feedback, such as a Microsoft Kinect®, can provide information to the therapist as to the movements attempted by the user. Delays however, representing both user reaction time and network delays, can skew the user's data to appear out of alignment with the virtual therapist. This may cause the user to produce unsatisfactory therapy scores even though they are correctly performing the maneuvers. Likewise, incorrect feedback from the user makes it impossible to provide corrective suggestions by the therapy program.

Systems and methods of the invention correct acquired data to adjust for both the human reaction time delay and any network variability to correct the user's data prior to matching it against the therapy program. By accounting for the two forms of delay, the system allows the user's performance to be scored against the virtual therapy and corrective instructions can be sent back to the user as needed. The system can be implemented over a cloud based network to improve performance across end-user devices.

Preferred systems and methods of the invention provide gesture-based dynamic time warping to address both human reaction delay latencies and network delay latencies. The present methods and systems evaluates the user's performance, segments gestures, as well as provides detailed textual/visual guidance in real time. Compared to the approach of D. S. Alexiadis, et al., “Evaluating a dancer's performance using kinect-based skeleton tracking,” in Proc. of the 19th ACM international conference on Multimedia (MM'11), Scottsdale, November, (2011), systems of the invention can align the user and the avatar instructor's motion data with inconstant human reaction delay and network delay. Compared A. Yurtman, and B. Barshan, “Detection and evaluation of physical therapy exercises by dynamic time warping using wearable motion sensor units,” Information Sciences and Systems (SIU'14), Trabzon, (April, 2014), methods and systems of the invention do not need any pre-recorded error template to evaluate the user's performance. Systems of the invention can operate online in real time and provide real-time guidance for the user, while these prior systems can only be applied offline when the entire motion sequence of the user is obtained. Unlike the cloud-based training system of Dennis Shen, Yao Lu and Sujit Dey “Motion Data Alignment and Real-Time Guidance in Avatar Based Physical Therapy Training System.” In Proceedings of IEEE International Conference on E-health Networking, Application & Services (Healthcom) (October 2015), the present invention addresses network delay caused by the wireless network and human reaction delay.

A preferred system and method conducts dynamic gesture based time warping. Sequences are rescaled on a time axis to provide a best match via a warping path. However, this is not done directly. Preprocessing first finds on an optimal path for comparison by aligning starting points prior to warping. Real time gesture segmentation is conducted with an estimation of global minimum determination. Nonlinear rescaling and accuracy testing can be conducted.

Preferred systems and methods of the invention have the ability to effectively and efficiently train people for different types of physical therapy tasks like knee rehabilitation, shoulder stretches, etc. Real-time guidance rather than mere scores can be provided, which allows a user to adjust to the guidance and better accomplish the recommended therapy movements. The systems and methods of the invention thereby adapt to the abilities of the user and can react to the user's performance by dynamically determining the necessary adjustments to establish optimal conditions.

Methods and systems account for human reaction delay (user delay to follow avatar instructions/motion) and mobile network delay (which may delay when the cloud rendered avatar video reaches the user device) and correctly calculate the accuracy of the user's movement compared to the avatar instructor's movement. Misalignment is accounted for and corrected. In particular, the delay may cause the two motion sequences to be misaligned with each other and make it difficult to judge whether the user is following the avatar instructor correctly or not. A dynamic time warping based algorithm addresses the motion data misalignment problem. While not bound to the theory, to the knowledge of the inventors, there have been no prior methods that utilize dynamic time warping to determine alignment between frames of a training video and user sensed movement. Yurtman et al. require templates and off-line analysis. Preferred methods of the invention also apply a gesture based dynamic time warping algorithm to segment the gestures among the whole motion sequence to enable real-time visual guidance to the user.

Experiments have demonstrated a prototype avatar based real-time guidance system in accordance with the invention using mobile network profiles. The experimental results show the performance advantage of present systems methods over other evaluation methods, and the ability of present methods and systems to conduct real-time cloud-based mobile virtual training and guidance.

Those knowledgeable in the art will appreciate that embodiments of the present invention lend themselves well to practice in the form of computer program products. Accordingly, it will be appreciated that embodiments of the present invention may comprise computer program products comprising computer executable instructions stored on a non-transitory computer readable medium that, when executed, cause a computer to undertake methods according to the present invention, or a computer configured to carry out such methods. The executable instructions may comprise computer program language instructions that have been compiled into a machine-readable format. The non-transitory computer-readable medium may comprise, by way of example, a magnetic, optical, signal-based, and/or circuitry medium useful for storing data. The instructions may be downloaded entirely or in part from a networked computer. Also, it will be appreciated that the term “computer” as used herein is intended to broadly refer to any machine capable of reading and executing recorded instructions. It will also be understood that results of methods of the present invention may be displayed on one or more monitors or displays (e.g., as text, graphics, charts, code, etc.), printed on suitable media, stored in appropriate memory or storage, etc.

Preferred embodiments of the invention will now be discussed with respect to the drawings. The drawings may include schematic representations, which will be understood by artisans in view of the general knowledge in the art and the description that follows. Features may be exaggerated in the drawings for emphasis, and features may not be to scale.

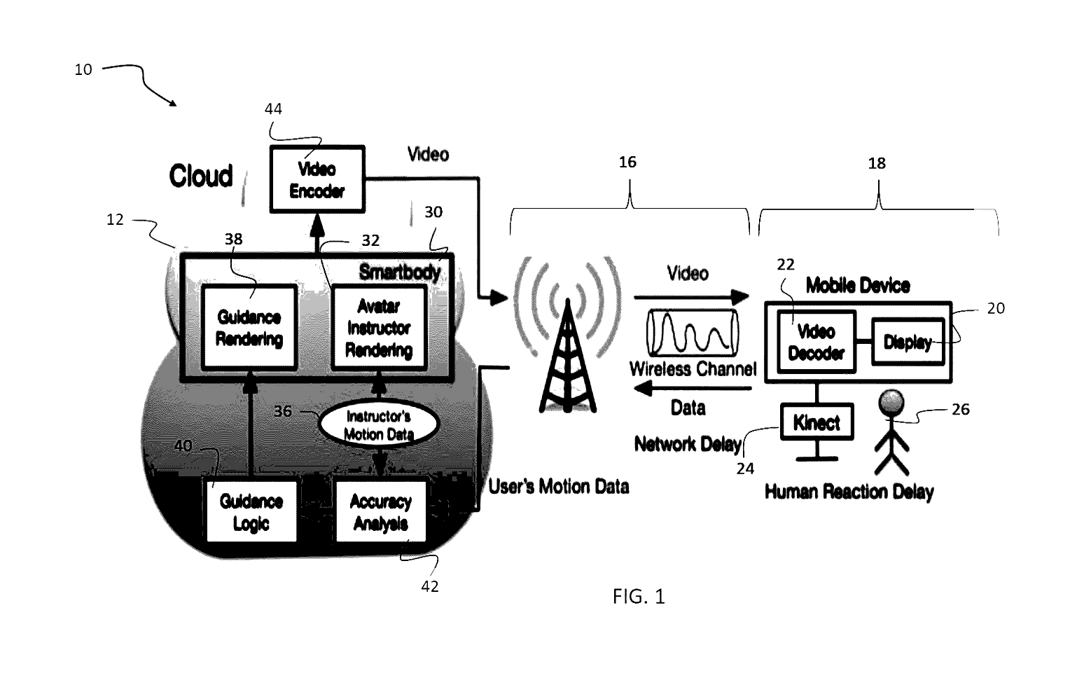

FIG. 1 illustrates the architecture of a preferred embodiment cloud-based virtual training system 10. A cloud server 12 communicates through a network 16 with a client 18, such as a mobile device, laptop, personal computer, game console or any other client device that includes a display 20, a video decoder 22 and can connect to a sensor 24 for sensing movements of a user 26. The network 16 can be a local network (such as in a health care facility) or a wide area network, such as the Internet, and can include wired or wireless access. In the example system 10, the network includes a wireless data channel The cloud server 12 includes a character animation platform 30. The animation platform 30 includes an instructor rendering module 32 that can sense via a camera or body worn sensors an instructor's 36 movements and a guidance rendering module 38 that can encode guidance based upon guidance logic 40. The guidance logic relies upon an accuracy analysis module 42 that compares user motion data to instructor motion data, while accounting for user and network delay via preferred methods of the invention.

In an experimental system according to FIG. 1, the animation platform 30 was realized with an open source character animation software platform called Smartbody [available online at http://smartbody.ict.usc.edu]. The character animation platform 30 is used offline to pre-recode an avatar instructor's movements for a physical therapy exercise. During a user home training session, the cloud server 12 uses the avatar instructor rendering 32 to render the avatar instructor for the exercise. A video encoder 44 encodes and transmits the avatar video through the wireless network 16 to the client 18. The user 26 watches decoded video from the decoder 22 on the display 20 and tries to follow it. Simultaneously, the user 26 movements are captured by the sensor 24, which was a Microsoft Kinect in the experimental system and uploaded to the cloud 12 through the wireless network 16. In the cloud 12, motion data of the avatar instructor 32 and user 26 are compared and analyzed by the accuracy analysis module 42 to determine accuracy of the user 26 movements. The results of accuracy are then processed by the guidance logic 40 followed by guidance rendering 38, and the guidance video is transmitted back to the client 18 through the wireless network 16.

In the experimental system, a Microsoft Kinect as the movement sensor 24 captures twenty joints of the user with and x, y, z component of movement for each joint. For a given exercise, some specific body parts might be deemed important and the system can select such important body parts. For frame i, the system 10 includes joint coordinates of these important body parts as the feature vector fᵢ. Apart from joint positions, some other quantities that are derived from the joint coordinates, like joint angles, can also be included in fᵢ. The combination of the feature vector for each frame is the motion data F−{f₁, f₂, . . . , fₘ} for the entire exercise.

Given the motion data of the avatar instructor and the user, the accuracy analysis module 42 computes the similarity of the two sequences to evaluate the performance of the user 26. The analysis module 42 accounts for misalignment caused by two kinds of delays in the system 10: human reaction delay and network delay. Advantageously, the system 10 does not need to measure or determine the human reaction delay or the network delay. There is no need to measure either of the human reaction delay or the network delay. Instead, the analysis module 42 aligns the sequences automatically without requirement of a measured, quantified or calculated delay amount.

Human Reaction Delay

After seeing the movement of the avatar instructor on the screen 20, it may take the user 26 some time to react to this movement and then follow it. This delay is defined as the time period from when the avatar instructor starts the motion till the user starts the same motion. For training exercises including multiple separate gestures, the user's reaction delay might be different for these gestures. A gesture is defined herein as a sequence that represents the meaningful action of some body parts, for example when these body parts move and then return to the initial position, or when there is an abrupt change in direction. For example, raising one's hand and then putting it down can be considered as a gesture. As another example, a step forward can be considered gesture and a subsequent step sideways another gesture. Gestures in a training exercise can also be segmented and defined offline by physical therapist as a single movement or a sequence of a few movements.

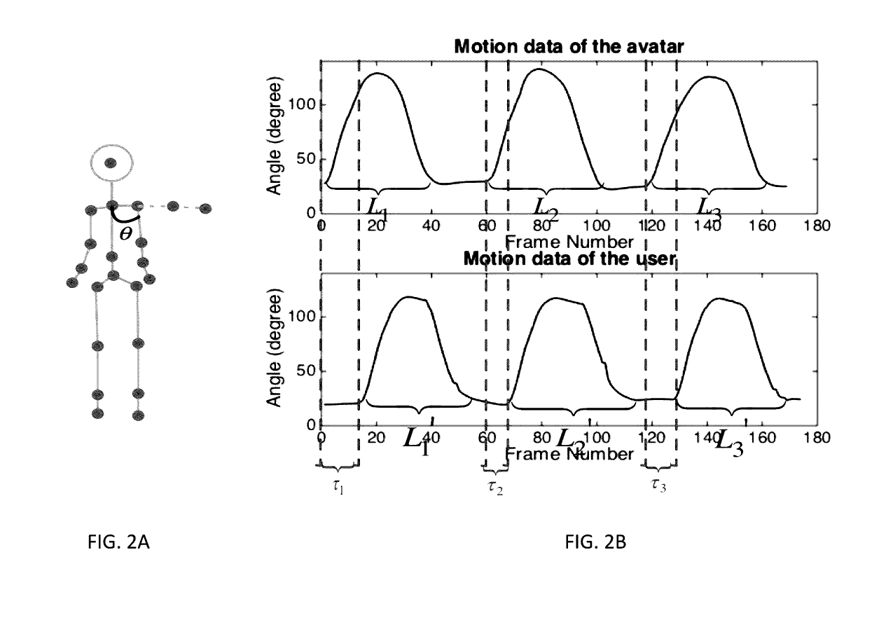

FIGS. 2A and 2B illustrate motion data of the avatar instructor and the user in an exercise of three gestures. For each gesture, the user follows the avatar instructor to laterally move his left arm from the solid position to the dotted position, and then return to the solid position. The corresponding motion data is the angle of the left shoulder θ. If there is only human reaction delay, we can assume that the user performs each gesture with time delay τ₁, τ₂ and τ₃ (τ₁≠τ₂≠τ₃) but the time length of the user gesture is close to that of the avatar instructor, i.e., L₁′≈L₁, L₂′≈L₂ and L₃′≈L₃, where Lᵢ and Lᵢ′ are the time length needed by the avatar instructor and usffer for gesture i respectively.

Network Delay

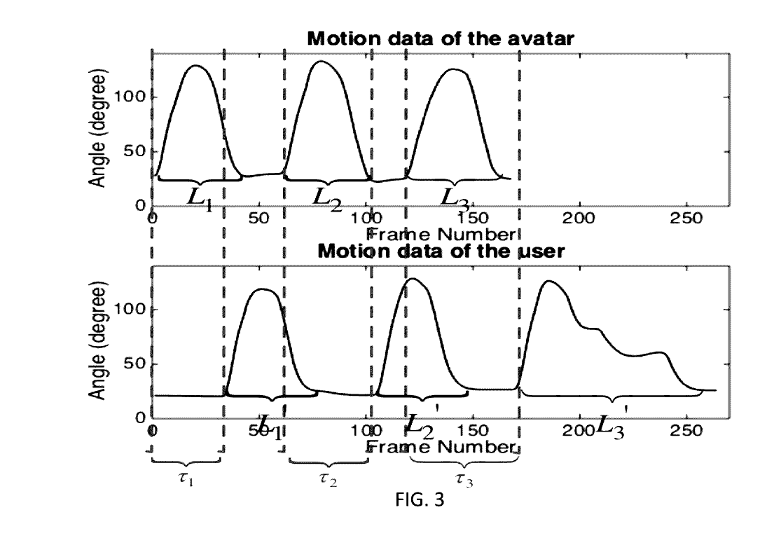

Delays can be added by the network 16, and the network delay can vary in response to many factors, such as bandwidth and the network load. Under the influence of network delay, the user may 26 not only perform later than the avatar instructor, but may also appear to perform more slowly in data received by the cloud 12, depending on the amount of network delay during a gesture. FIG. 3 illustrates that with network delay, the time length of the user's gesture might be much longer than that of the avatar instructor's corresponding gesture as compared to FIG. 2B, where only human delay is taken into account. Techniques in the background, such as MCC, will be unreliable in such an occurrence. When the two sequences are different in length, a frame in the avatar instructor's motion sequence does not match the frame in the user's motion sequence that contains the corresponding movement of the user. To align the two sequences effectively and calculate their similarity, the present accuracy analysis module 42 rescales them on the time axis, i.e., extend or shrink the sequence horizontally, to match the total length of the other sequence.

Gesture Based Dynamic Time Warping

The accuracy analysis module 42 in preferred embodiments conducts gesture based dynamic time warping. This technique is a modification of dynamic time warping, which is a technique often used in speech processing. See, D. J. Berndt, and J. Clifford, “Using Dynamic Time Warping to Find Patterns in Time Series,” KDD workshop, Vol. 10. No. 16. (1994). Dynamic time warping as applied to speech processing measures the similarity of two sequences by calculating their minimum distance. Given sequences A={a₁, a₂, . . . , aₘ} and B={b₁, b₂, . . . , bₙ}, an m×n distance matrix d is defined and d(i, j) is the distance between aᵢ and bⱼ

d(i, j)=\sqrt{|aᵢ−bⱼ|²} (3)

To find the best match or alignment between the two sequences, a continuous warping path through the distance matrix d should be found such that the sum of the distances on the path is minimized. Hence, this optimal path stands for the optimal mapping between A and B such that their distance is minimized. The path is defined as P={p₁, p₂, . . . , p_{q}} where max{m,n}≦q≦m+n−1 and pₖ=(xₖ, yₖ) indicates that aₓₖ is aligned with b_{yk} on the path. Moreover, this path is subject to the following constraints

Boundary constraint: p₁=(1,1), p_{q}=(m,n)

Monotonic constraint: xₖ₊₁≧xₖ and yₖ₊₁≧yₖ

Continuity constraint: xₖ₊₁−xₖ≦1 and yₖ₊₁−yₖ≦1

Under the three constraints, this path should start from (1,1) and ends at (m, n). At each step, xₖ and yₖ will stay the same or increase by one.

To find this optimal path, an m×n accumulative distance matrix S is constructed where S(i, j) is the minimum accumulative distance from (1,1) to (i, j). The accumulative distance matrix S can be represented as the following.

$$S ( i , j ) = d ( i , j ) + min \{ \begin{matrix}S ( i - 1 , j - 1 ) \\ S ( i , j - 1 ) \\ S ( i - 1 , j )\end{matrix} \qquad ( 4 )$$

S(m,n) is defined as the DTW distance of the two sequences; smaller DTW distance indicates that the two sequences are more similar The corresponding path indicates the best way to align the two sequences. In this way the two sequences are rescaled on the time axis to best match with each other. Time complexity of the DTW method is Θ(mn).

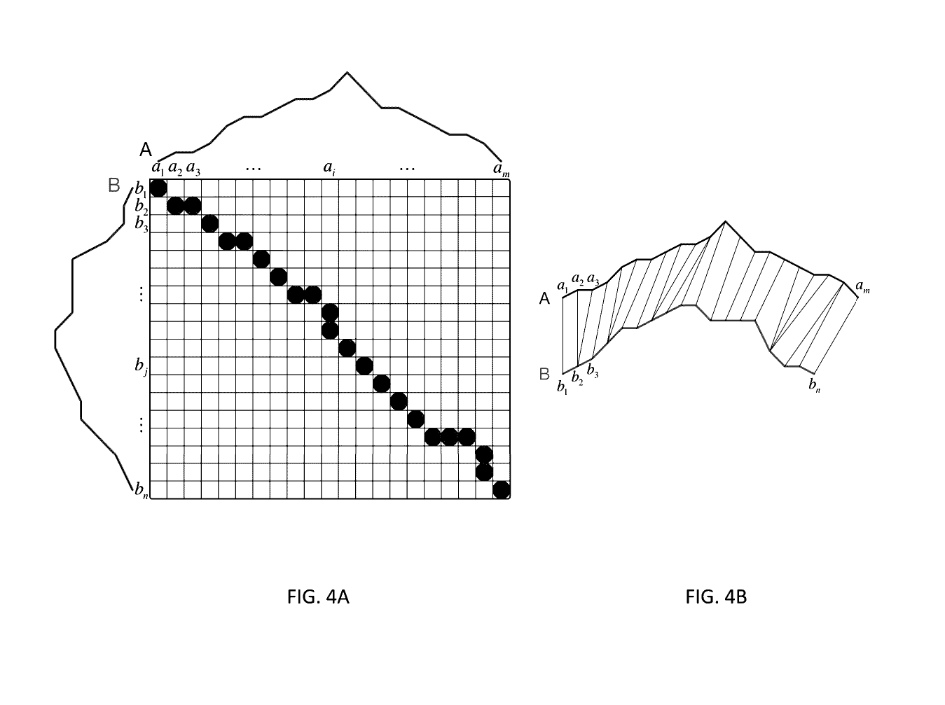

FIG. 4A shows an example of two sequences A and B. The dot elements construct a path from (1,1) to (m,n) on which the accumulative distance is minimized, and is the optimal mapping path of A and B. FIG. 4B shows the corresponding alignment method given by the optimal path in FIG. 4A. For example, a₁ is aligned with b₁, a₂ and a₃ are aligned with b₂. In speech recognition, the dynamic time warping distance is calculated from a tested speech sample and several templates, with the sample classified as the pattern with the minimum dynamic time warping distance.

The accuracy analysis module 42 conducts data preprocessing and alignment to utilize dynamic time warping. The data misalignment problem caused by human reaction delay and network delay allows dynamic time warping to be used to rescale the two sequences on the time axis to align them, but only after pre-processing provided by the invention. Directly applying dynamic time warping on two sequences to evaluate their similarity is unreliable because the absolute amplitude of data may have influence on the optimal path and therefore the alignment result. An example illustrates this problem. For two sequences A={a₁, a₂, . . . , aₘ} and B={b₁, b₂, . . . , bₙ}, if one applies dynamic time warping on them, the alignment result is not expected to change if a constant c is added to B. However, when computing the new distance matrix of A and B′=B+c, (3) becomes:

$$\begin{matrix}{d}^{′} ( i , j ) = \sqrt{{\vert {a}_{i} - {b}_{j}^{′} \vert}^{2}} \\ = \sqrt{{\vert {a}_{i} - ( {b}_{j} + c ) \vert}^{2}} \\ \neq d ( i , j ) + c\end{matrix} \qquad ( 5 )$$

Therefore, the new distance matrix d′ is different from d not only for the constant c. The relative size of elements in d is changed. Consequently, the choice in (4) at each step might be different and S′≠S+c. So B′ is aligned with A in a different way.

To solve this problem, the present invention preprocesses the data before applying dynamic time warping by aligning the two starting points a₁ and b₁ as (6):

B′=B+(a₁−b₁) (6)

Applying dynamic time warping on A and B′, we can obtain the optimal path P* and the DTW distance S′(m,n) for A and B:

$${S}^{′} ( m , n ) = {\sum }_{( i , j ) ∈ {P}^{*}} \sqrt{{\vert {a}_{i} - {b}_{j}^{′} \vert}^{2}} \qquad ( 7 )$$

so the DTW distance S(m,n) between the original data A and B is

$$S ( m , n ) = {\sum }_{( i , j ) ∈ {P}^{*}} \sqrt{{\vert {a}_{i} - {b}_{j} \vert}^{2}} \qquad ( 8 )$$

A={a₁, a₂, . . . , aₘ} and B={b₁, b₂, . . . , bₙ} are the training avatar and user's motion sequence, respectively. a₁ is the first point of sequence A. b₁ is the first point of B. The goal is to add a constant k to B (then B becomes B′), so that the first point in B′ equals aIn this way, it is possible to first find out the optimal path P* using the preprocessed data A and B′, and then calculate the dynamic time warping distance for the original data A and B. The remaining description assumes that such preprocessing has been conducted.

Since the dynamic time warping distance S(m,n) is a similarity measurement for the two sequences, the method normalizes S(m,n) over an arbitrary range, e.g., to 0˜100 as evaluation score for the user. Smaller S(m,n) represents higher score and indicates that the two sequences are more similar and the user performs better.

In a physical training session using the present system, there are multiple ways to provide guidance to the user to help the user calibrate user movements. For example, an entire replay of the movements that the user has performed together with the avatar instructor's movements can be provided after the user has done the whole training set (˜several minutes). This can be classified as a non-real time feedback. However, the present system can provide feedback after the user finishes each gesture (˜a couple of seconds) which can be considered as a real-time feedback.

For a given physical training exercise, gestures in the avatar instructor's motion sequence have been predefined and segmented by the physical therapist. Suppose that A₁={a₁, a₂, . . . , aₘ₁} is defined as the first gesture in the avatar instructor's sequence A={a₁, a₂, . . . , aₘ}. Dynamic time warping can be used to find the subsequence of the user's motion data which matches the avatar instructor's gesture A₁ best. A modified dynamic time warping algorithm that can be called subsequence dynamic time warping is used to search for a subsequence inside a longer sequence that optimally fits the other shorter sequence. Suppose that the starting point of one gesture is straight after the endpoint of the last gesture, one can fix the starting point of the subsequence as b₁. For the subsequence {b₁, b₂, . . . , bₖ} (k=2, 3, . . . , n) of the user, its dynamic time warping distance with the avatar's gesture A₁ is S(m₁,k). The optimal endpoint n₁ of the user's gesture should be the frame that leads to the best match between the two sequences and gives the minimum dynamic time warping distance:

$${n}_{1} = {argmin}_{k} \{ S ( {m}_{1} , k ) \} \qquad ( 9 )$$

If prior techniques for dynamic time warping were applied, due to the existence of local minimum points, the endpoint of the user's gesture cannot be determined until we obtain the whole motion sequence of the user. The entire sequence B={b₁, b₂, . . . , bₙ} is searched to find out the global minimum point. This means searching from k=2 to k=n to find out the global minimum point, which requires significant computation. Methods and systems of the invention instead analyze a subsequence of the data, corresponding to a gesture, and avoid the need to search for a global minimum in an entire motion sequence of the user. A global minimum point is instead estimated by analysis of subsequences.

The accuracy analysis module 42 in the system 10 of FIG. 1 estimates the global minimum point without testing k from 2 to n. For the global minimum point n₁, it is known that B₁={b₁, b₂, . . . , bₙ} matches A₁={a₁, a₂, . . . , aₘ₁} best. When the user completes one gesture, the user may stay in the end position for some frames to provide movement transition data, and the feature vector of these frames will be quite close to bₙ₁. So if e more frames are tested after n₁, it is likely that all of these following frames {bₙ₁₊₁, bₙ₁₊₁, . . . , bₙ₁₊ₑ} will be aligned to aₘ₁. From this insight, the global minimum point can be estimated as follows. For each frame k of the user, calculate the similarity of current subsequence {b₁, b₂, . . . , bₖ} and the avatar instructor's gesture A₁={a₁, a₂, . . . , aₘ₁} and get the DTW distance S(m₁,k). When k increases from 2, S(m₁,k) keeps decreasing in the beginning If S(m₁, k+1)>S(m₁, k), frame k is a local minimum point. To determine whether it is the global minimum point, continue testing e frames and record dynamic time warping distances Sₜᵣᵤₑ={S(m₁,k+1), S(m₁,k+2), . . . , S(m₁,k+e)}. In the meantime, compute the estimated dynamic time warping distances S_{estimated}={S′(m₁,k+1), S′(m₁,k−2), . . . , S′(m₁,k+e)} for the case where all of the following frames {bₖ₊₁, bₖ₊₁, . . . , bₖ₊ₑ} are aligned with aₘ₁. In other words, for the e frames following the minimum point k, (4) becomes:

S′(m₁,k+j)=d(m₁,k+j)+S′(m₁,k+j−1) (10)

where j=1, 2, . . . , e. Then for the true distance Sₜᵣᵤₑ and the estimated distance S_{estimated}, the relative error vector is

error=|S_{estimated}−Sₜᵣᵤₑ|·/Sₜᵣᵤₑ (11)

An error tolerance threshold δ is used to measure the relative error. S_{estimated}−Sₜᵣᵤₑ| is the absolute error between Sₜᵣᵤₑ and S_{estimated}. |S_{estimated}−Sₜᵣᵤₑ|·/Sₜᵣᵤₑ is the relative error In the experiments we use e=20 and δ=5%. These values were determined experimentally to provide good results. A preferred assumption is based upon the user completing one gesture, and the user may stay in the end position for a short time (˜1 s, which is ˜30 frames). In this instance, when e<30, larger e means higher accuracy and larger computation., but when e>30, the assumption may not hold. An example practical range for e is from 15-30. Larger values of δ can result in false detection (which means that the point which satisfies Mean(error)<δ may not be the global minimum). Too small δ may result in failure in detection (which indicates that the method cannot find a point where Mean(error)<δ holds, even at the true global minimum). A practical example range for δ is 3%˜10%. If the average relative error Mean(error)<δ, it is concluded that the local minimum point at k is the global minimum point and therefore the endpoint of this gesture. Otherwise continue to test the next local minimum point. Transitions or pauses in physical gesture movements create a natural subsequence, but the selection of subsequences can also be a predetermined number of frames that don't correspond to a discrete physical gesture. Gestures for purposes of analysis can therefore correspond to a physical gesture, a portion of a physical gesture, a portion of sequential physical gestures, or a limited number of sequential physical gestures.

In sum, for each local minimum point k, decide/estimate whether it's the global minimum point. The following assumption is used: if k is the global minimum point, then frame k+1, k+2, . . . , k+e in user sequence B will all be aligned with frame ml of the avatar instructor's sequence A when DTW is applied to A and B. Based on this assumption, calculate two vectors for each local minimum point k. (1) Sₜᵣᵤₑ={S(m₁,k+1), S(m₁,k+2), . . . , S(m₁,k−e). This is the true DTW warping distance vector for the sequence of frames. (2) S_{estimated}={S′(m₁,k+1), S′(m₁,k+2), . . . , S′(m₁,k+e)}. This vector is the estimated DTW warping distance vector based on the above assumption. Then, compare Sₜᵣᵤₑ and S_{estimated} using equation (11). (11) calculates the relative error between Sₜᵣᵤₑ and S_{estimated}. If Sₜᵣᵤₑ and S_{estimated} are within a predetermined error, the assumption is successful for this local minimum point, and this local minimum point can be used as an estimate of the global minimum point.

Using this approach, gesture segmentation is implemented in the process of dynamic time warping and scores for different gestures can be provided to the user in real time. Subsequences can be defined offline as a preliminary step when recording training avatar data. For the user data, the present method can to align subsequences in the data with subsequences in the avatar data and finds the corresponding gestures The present methods are able to align the two sequences perfectly with the existence of any kinds of delay in the user data. For each gesture, the extra complexity to test local minimum points is only Θ(m₁e). Moreover, if B₁={b₁, b₂, . . . , bₙ₁} is determined as the gesture related to the avatar instructor's gesture A₁={a₁, a₂, . . . , aₘ₁}, dynamic time warping can be conducted from the new starting point (m₁+1, n₁+1).

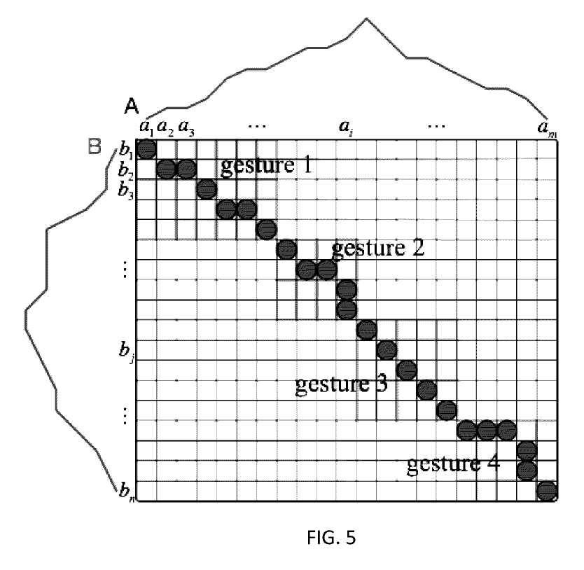

FIG. 5 shows the example of applying the present gesture based dynamic time warping on the same sequences as in FIGS. 4A and 4B. Suppose that there are four gestures in the exercise, segmentation allows dynamic time warping to be performed separately for each gesture. The shaded area shows the computation cost for each gesture. One grid indicates a need to compare one frame in A and one frame in B once. Quantitative analysis has also been conducted. In our experiments, an exercise includes 5 gestures. The typical running time is 120˜140 ms for DTW, and 20˜30 ms. GB-DTW needs only ⅕ of time compared with DTW to align the two sequences in a task of 5 gestures. For some training exercises, the motion sequences of the user and avatar instructor might be quite long and the default dynamic time warping requires large computation complexity Θ(mn). Suppose that there are g gestures in a training exercise, so each gesture of the avatar instructor contains Θ(m/g) frames and each gesture of the user contains Θ(n/g) frames. The complexity of dynamic time warping on each gesture is Θ(mn/g²). For each gesture Θ(em/g) complexity is also needed to test local minimum points. So the total complexity of gesture based dynamic time warping becomes

$$Θ ( g \times \frac{mn}{{g}^{2}} ) + Θ ( g \times \frac{em}{g} ) = Θ ( m ( \frac{n}{g} + e ) ) = Θ ( \frac{mn}{g} ) << Θ ( mn ) \qquad ( 12 )$$

when g is large, the present gesture segmented method can significantly decrease the computation complexity compared to default dynamic time warping on the entire sequence.

Based on the alignment result given by the optimal warping path in each gesture, rescaling of the two motion sequences nonlinearly on the time axis can be conducted to match them. When multiple adjacent frames in one sequence are aligned with one single frame in the other sequence, the single frame will be repeated for several times. For example, if Â={aᵢ, aᵢ₊₁, . . . , a_{i+w-1}} of the avatar instructor are aligned with bⱼ of the user, w-1 frames identical with bⱼ will be inserted after frame j. In this way the user's movement in each frame matches the corresponding movement of the avatar instructor.

Real Time Experiment of Gesture Segmented Dynamic Time Warping.

In the experiment 10 subjects (aged 18˜30, 7 males, 3 females) were required to perform a gesture designed by a physical therapist nine times. For one performance of each subject, the subject receives an evaluation Y ∈ {0,1} from the physical therapist where Y=0 represents good performance and Y=1 indicates that he fails the gesture. In the meantime, the cloud-based virtual training system of FIG. 1 captures the subject's movement, processes the motion data and provides an evaluation score S ∈[0,100]. Therefore we have a positive dataset {S|Y=1} and a negative dataset {S|Y=0}. According to Bayesian Decision Theory, the optimal classification threshold for the two classes is:

P_{S|Y}(s|0)P_{Y}(0)=P_{S|Y}(s|1)P_{Y}(1) (13)

where P_{Y}(y) is the prior probability of each class. Assuming that the two classes are Gaussian-distributed,

$${P}_{S \vert Y} ( s \vert y ) = \frac{1}{\sqrt{2 {πσ}_{y}}} exp [ - \frac{{( s - {u}_{y} )}^{2}}{2 {σ}_{y}^{2}} ] \qquad ( 14 )$$

where μ_{y} is the sample mean and σ_{y}² is the sample variance of classy. From (13) and (14) the following is provided:

$$\frac{{( s - {μ}_{0} )}^{2}}{{σ}_{0}^{2}} - \frac{{( s - {μ}_{1} )}^{2}}{{σ}_{1}^{2}} + log ( 2 π \frac{{σ}_{0}^{2}}{{σ}_{1}^{2}} ) - 2 log \frac{{P}_{Y} ( 0 )}{{P}_{Y} ( 1 )} = 0 \qquad ( 15 )$$

The solution s₀ of (15) is the optimal threshold for the evaluation score S given by the system. From the experiment we get s₀=62.8. Scores below 62.8 would benefit from real-time guidance from the system.

Experiments also tested providing users visual and textual guidance through the system. First, we will discuss different alignment types in the result of gesture based dynamic time warping. Here we define the monotonicity of a subsequence Â={aᵢ, aᵢ₊₁, . . . , a_{i+w-1}} as follows. If all the features of Â are monotonic (i.e. keep increasing or decreasing) then Â is monotonic, or else it is non-monotonic. Suppose that all the frames in Â={aᵢ, aᵢ₊₁, . . . , a_{i+w-1}} are aligned to bⱼ, then there are two different cases. If Â is monotonic, it means that the effects of multiple frames in Â are similar to the effect of bⱼ, which indicates that B is faster than A at that time. If Â is non-monotonic, it means that some reciprocating movements in Â are aligned to one single frame bⱼ. Thus B's gesture is incomplete for this reciprocating motion. Based on different alignment ways between the avatar instructor and the user, we summarize in Table 1 four types of alignments and their corresponding feedback (used as textual guidance) for the user.

TABLE 1
Four types of alignment and textual guidance

Number
of frames

| | Avatar | | | Textual |
|---|---|---|---|---|
| Type | Instructor | User | Monotonicity | Guidance |
| 1 | >1 | 1 | Monotonic | Too Fast |
| 2 | 1 | >1 | | Too Slow |
| 3 | 1 | >1 | Non-Monotonic | Overdone |
| 4 | >1 | 1 | | Incomplete |

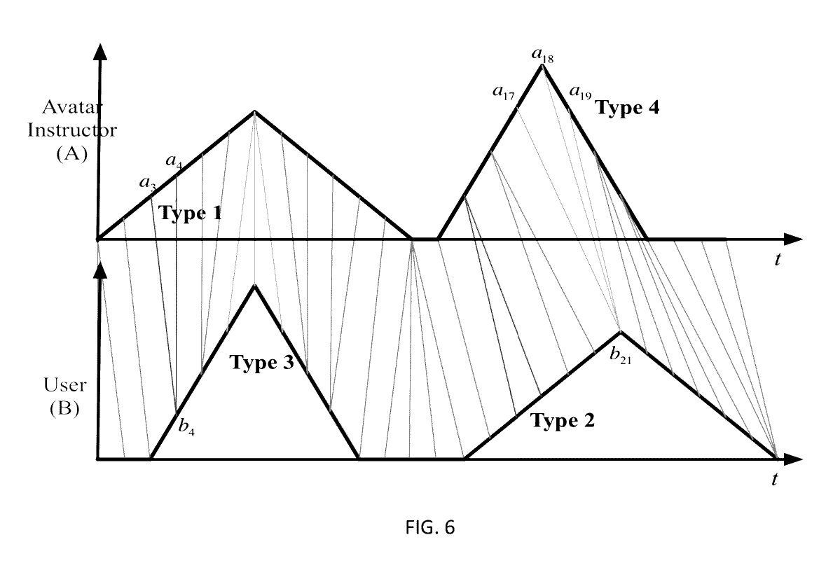

FIG. 6 illustrates the four types. For example, in type 1 the user performs faster than the avatar instructor so monotonic subsequence {a₃, a₄} of the avatar instructor is aligned with one single frame b₄ of the user. In type 4 the user's gesture does not reach the required amplitude (i.e., incomplete gesture), so non-monotonic subsequence {a₁₇, a₁₈, a₁₉} of the avatar instructor is aligned with one single frame b₂₁ of the user.

Next, we discuss how to calculate accurate evaluation score for each gesture based on the different kinds of training exercises and the types of alignments discussed above. Above, S(m₁, n₁) is used to provide evaluation score for the user. However, when the user performs faster or slower than the avatar instructor as type 1 and 2, the difference between the two sequences is counted several times. For example, if all the frames in Â={aᵢ, aᵢ₊₁, . . . , a_{i+w-1}} are aligned to bⱼ, then the accumulative distance for this part is

$$\hat{D} = {\sum }_{k = 0}^{w - 1} \sqrt{{\vert {a}_{i + k} - {b}_{j} \vert}^{2}} \qquad ( 16 )$$

However, for some training exercises where speed is not important, the distance should be counted for only once, and (16) can be revised as

$$\hat{{D}^{′}} = \sqrt{{\vert ( \frac{1}{w} {\sum }_{k = 0}^{w - 1} {a}_{i + k} ) - {b}_{j} \vert}^{2}} \qquad ( 17 )$$

Therefore, for exercises in which speed is not important, we use (17) to calculate the evaluation score. For exercises where speed should be considered, the original accumulative distance in (16) is used.

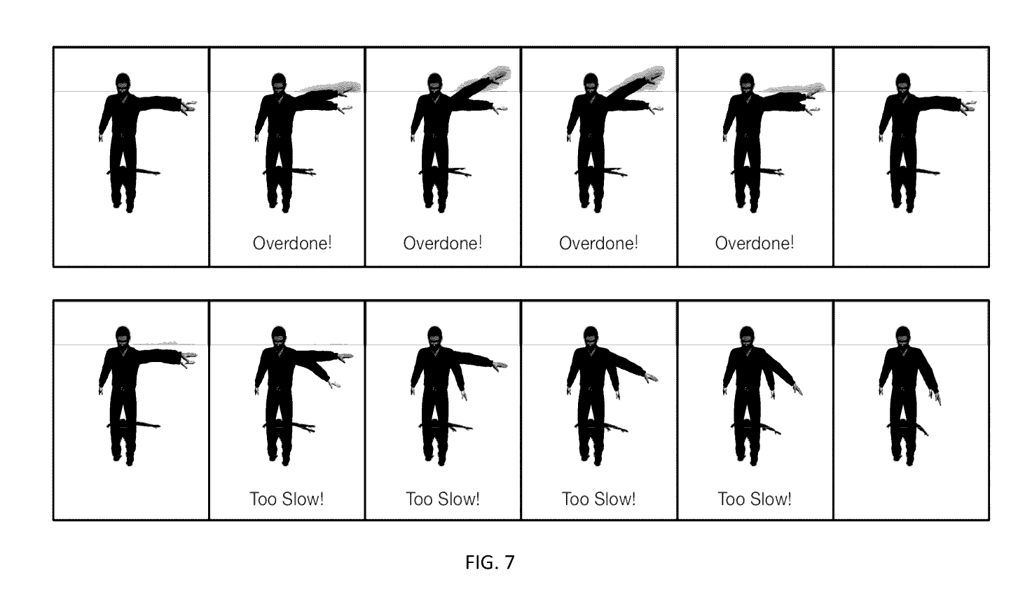

After completing one gesture, the user can see the score of his performance on the screen. To better help the user calibrate this performance for any low-score gesture, a replay system can provide two kinds of guidance (visual and textual guidance) for the user. Firstly, the rescaled movements of the avatar instructor together with the rescaled movements of important body parts of the user are shown on the screen. In this way, the user can see the difference of his movements and the avatar instructor's and know how to correct his performance. Secondly, according to the four types in Table 1, textual guidance can be shown on the screen to remind the user about his error type if he made mistakes in speed or movement range of the gesture. (For those exercises in which speed is not important, type 1 and 2 will be ignored.) FIG. 7 is a sequence of visual and textual guidance provided to the user through the display.

Results

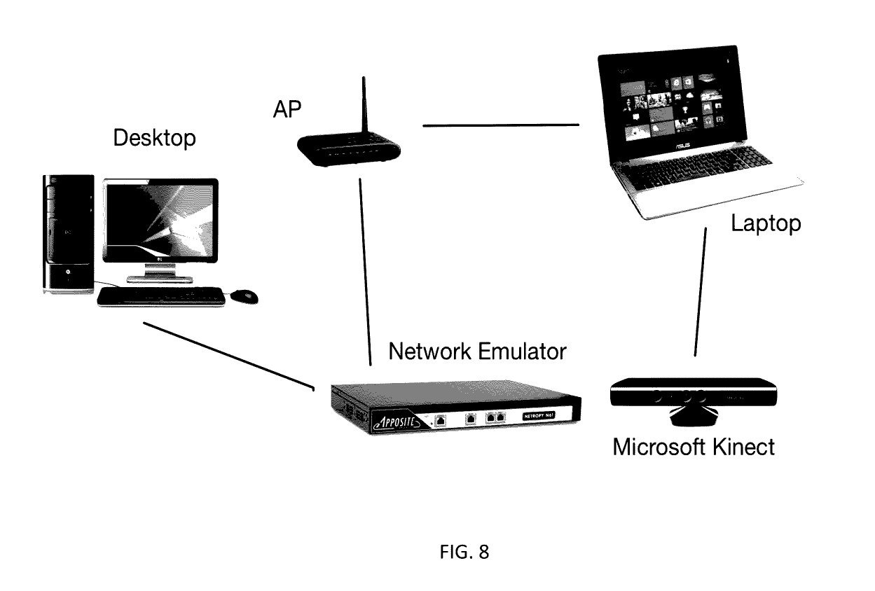

The experiments are based on a testbed (shown in FIG. 8) we developed to emulate the system architecture in FIG. 1. The cloud server is a quad core 3.1 GHz CPU with 8 GB RAM, and the mobile device is a laptop PC with a dual core 2.5 GHz CPU and 4 GB RAM. The network connection between the server and the mobile laptop is emulated using a network emulator (Linktropy), which can be programmed to emulate different wireless network profiles.

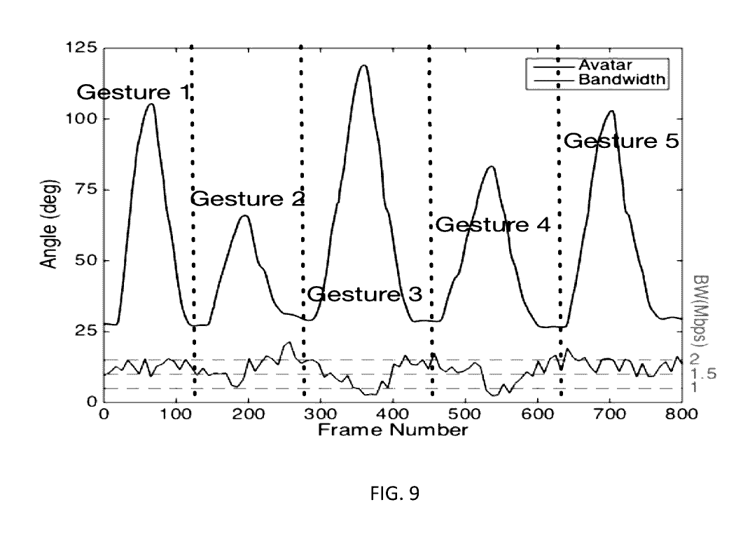

The tested exercise is laterally moving one's left arm from the solid position to the dotted position and then returning to the solid position with different angle θ for five times. The angle of the left shoulder is measured and five gestures are defined for this exercise. The avatar instructor's motion data for the five gestures are shown as the upper curve in FIG. 9.

Results obtained with the present methods and system were compared to the prior traditional method of MCC and default dynamic time warping on the entire sequence that is searched through for a global minimum as discussed above. Data was obtained by calculating a correlation coefficient for the aligned sequences x and y in each method. The correlation coefficient P is defined as:

$$ρ = \frac{E [ ( x - \overline{x} ) ( y - \overline{y} ) ]}{\sqrt{{σ}_{x}^{2} {σ}_{y}^{2}}} \qquad ( 18 )$$

where x̅, y̅ are the means of x y and σₓ², σ_{y}² are the variances. High correlation coefficient indicates that the two sequences are aligned better. Comparing the original motion sequences of different users, we observed that the human reaction delay of two users, Users A and B, was smaller than that of User C. In addition, all of the three users perform worse with fluctuating bandwidth than ideal network condition due to the network delay. Especially at the third and fourth gesture when bandwidth is limited, the users perform more slowly than the avatar instructor. Comparing the three methods, we determined that under ideal network condition with only human reaction delay, the traditional method of MCC gives high correlation coefficients (ρ>0.85). However, when the network condition is not ideal and therefore large network delay is accumulated, the two dynamic time warp methods perform much better (ρ>0.95) than MCC (ρ<0.80). Default dynamic time warping and present gesture based dynamic time warping provided alignment results that were quite close and both of their correlation coefficients are more than 0 95. The gesture based dynamic time warping, however, provides a level of perfect alignment like default dynamic time warping but avoids computational complexity of default dynamic time warping and therefore enables real-time visual guidance instead of merely allowing guidance off-line after a complete sequence is received.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A server for virtual training that transmits avatar video data through a network for use by a display device for displaying a virtual trainer and receives user data generated by a gesture acquisition device for obtaining user responsive gesture data, the server including a processor running code that resolves user gestures in view of network and user latencies, wherein the code aligns subsequences in the user responsive gesture data with subsequences in the avatar video data and generates correction data to send through the network for use by the display device.

2. The server of claim 1, wherein the correction data is generated and sent through the network in real time for display by the display device.

3. The server of claim 2, wherein the correction data comprises avatar video data.

4. The server of claim 3, wherein the correction data comprises text data.

5. A virtual training system including the server of claim 1, the system further comprising a client device, the client device comprising a video encoder for encoding the avatar video data, the display device for displaying the virtual trainer, a gesture acquisition device for sensing user movements, and a network interface for receiving the avatar video data and transmitting the user responsive gesture data to the server.

6. The server of claim 1, wherein the code aligns subsequences via modified dynamic time warping, wherein the modified dynamic time warping comprises pre-processing to first align two starting points by shifting a subsequence in the user responsive gesture data by a constant to align with a first point in a subsequence of the avatar video data and produce pre-processed data.

7. The server of claim 6, comprising finding an optimal warping path to the preprocessed data and then applying the optimal path to subsequences in the user responsive gesture data and the avatar video data.

8. The server of claim 6, wherein an optimal endpoint of user responsive gesture data is selected as a frame of the data the leads to the best match between subsequences in the user responsive gesture data and the avatar video data and provides the minimum dynamic time warping distance.

9. The server of claim 8, wherein the code estimates a global minimum point by detecting a movement transition data, determining a local minimum point for a subsequence of data between movement transition data, and then testing for a global minimum for a number of following frames via calculation of warping distances.

10. The server of claim 9, wherein the code further computes estimate dynamic time warping distances for subsequent frames and calculates an error vector between this estimated warping distances and the true warping distances for the subsequent frames.

11. The server of claim 10, wherein the code determines a global minimum when the error vector is less than a predetermined threshold.

12. The server of claim 11, wherein the code calculates two dynamic time warp vectors to test each local minimum point in subsequences, wherein the two vectors include a true dynamic time warp distance vector and an estimated dynamic time warp distance vector and assigns a global minimum point when the true dynamic time warp distance vector and an estimated dynamic time warp distance vector are within a predetermined error range.

13. The server of claim 1, wherein the subsequences in the user responsive gesture data and the subsequences in the avatar video data correspond to individual physical gestures in a sequence of physical gestures.

14. The server of claim 1, wherein the subsequences in the user responsive gesture data and the subsequences in the avatar video data correspond to a predetermined number of frames.

15. A method for aligning avatar video data with user responsive gesture data, the method comprising steps of:
dividing the user responsive gesture data into subsequences by testing for local minimums in a subsequence of frames and calculating warping distances, and then testing subsequent frames to find an estimated global minimum that meets a predetermined error threshold range;
dynamic time warping subsequences in the user responsive data with subsequences in the avatar video data; and
generating correction data from said dynamic time warping.

16. The method of claim 15, comprising preprocessing the user responsive gesture data by aligning the starting points of subsequences in the user responsive gesture data and the avatar video data.

17. The method of claim 16, wherein the subsequences in the user responsive gesture data and the subsequences in the avatar video data correspond to individual physical gestures in a sequence of physical gestures.

18. The method of claim 16, wherein the subsequences in the user responsive gesture data and the subsequences in the avatar video data correspond to a predetermined number of frames.

19. The method of claim 15, wherein the dividing calculates two dynamic time warp vectors to test each local minimum point in subsequences, wherein the two vectors include a true dynamic time warp distance vector and an estimated dynamic time warp distance vector and assigns a global minimum point when the true dynamic time warp distance vector and an estimated dynamic time warp distance vector are within the predetermined error threshold range.
